(19) United States
(12) Patent Application Publication
(10) Pub. No.: US 2013/0124210 A1
(43) Pub. Date: May 16, 2013

(54) INFORMATION TERMINAL, CONSUMER ELECTRONICS APPARATUS, INFORMATION PROCESSING METHOD AND INFORMATION PROCESSING PROGRAM

(71) Applicant: Kabushiki Kaisha Toshiba, Tokyo (JP)

(72) Inventors: Kazushige OUCHI, Saitama-shi (JP); Yasunobu YAMAUCHI, Yokohama-shi (JP); Toshiaki NAKASU, Tokyo (JP)

(73) Assignee: KABUSHIKI KAISHA TOSHIBA, Tokyo (JP)

(21) Appl. No.: 13/675,313

(22) Filed: Nov. 13, 2012

(30) Foreign Application Priority Data
Nov. 16, 2011 (JP) 2011-250959

(51) Int. Cl. G06F 3/16

(52) U.S. Cl. CPC G06F 3/167
USPC 704/275; 340/3.71

(57) ABSTRACT

According to an information terminal connectable to a target apparatus, including a determining unit and a control unit wherein the determining unit determines whether the information terminal is held by a user or not, the control unit perform to output, when changed from a status of being held to a status of not being held, a control signal to instruct accepting an operation given from the user to the target apparatus, and the control unit performs, when changed from the status of not being held to the status of being held, at least either one of displaying a remote controller to operate the target device on a display screen of the information terminal or acquiring information on a status of the target apparatus from the target apparatus to display the information on the display screen.

### CROSS REFERENCE TO RELATED APPLICATIONS

This application is based upon and claims the benefit of priority from the prior Japanese Patent Application No. 2011-250959, filed on Nov. 16, 2011, the entire contents of which are incorporated herein by reference.

### FIELD

Embodiments described herein relate generally to an information terminal, a consumer electronics apparatus, an information processing method and an information processing program, and more particularly to an information terminal capable of operating at least one or more consumer electronics apparatuses.

### BACKGROUND

A multiplicity of home apparatuses is attached with remote controllers dedicated to the apparatuses, and a plurality of remote controllers exists in one room in many cases. In such a case, when operating the apparatus, a desired operation is performed in a way that holds the remote controller for the apparatus with a hand. However, it often happens that the remote controller is hard to be found out. A main cause thereof is that the plurality of remote controllers exists in one room. As one of those devised to obviate this problem, a multi-function remote controller, which is a single remote controller, enabled to operate the plurality of apparatuses is given.

On the other hand, for registering the operations of the plurality of apparatuses in one remote controller, it is necessary to register individually an infrared-ray signal emitted by the dedicated remote controller. However, there is a system enabling an inexperienced person to easily register through a mechanism for readily registering types of the consumer electronics apparatuses.

Even when integrating the plurality of remote controllers into one remote controller, however, this integrated remote controller needs using at all times for operating the consumer electronics apparatus.

### BRIEF DESCRIPTION OF THE DRAWINGS

FIG. 1 is a block diagram illustrating configurations of an information terminal and a consumer electronics apparatus according to an embodiment.

FIG. 2 is a schematic view showing examples of the information terminal and the consumer electronics apparatus.

FIG. 3 is a schematic view schematically illustrating an external appearance of a television set by way of one example of the consumer electronics apparatus.

FIG. 4 is a schematic view showing one example of a hardware configuration of the information terminal.

FIG. 5 is a schematic view showing one example of a hardware configuration of the consumer electronics apparatus.

FIG. 6 is a flowchart illustrating a flow of processing operation of an information terminal 100 in the present embodiment.

FIG. 7 is a flowchart illustrating a flow of processing operation of a consumer electronics apparatus 200 in the present embodiment.

FIG. 8 is a schematic view showing an example of displaying a controller screen suited the apparatus 200 (TV receiver) in the present embodiment

FIG. 9 is a schematic view showing an example of displaying an operating instruction of the sensor unit on the side of the TV receiver 200 on the information terminal 100 in the present embodiment.

FIG. 10 is a schematic view showing an example of displaying information about the TV receiver 200 on the information terminal 100 in the present embodiment.

FIG. 11 is a schematic view showing an example of displaying the information about the TV receiver 200 on the information terminal 100 in the present embodiment.

FIG. 12 is a schematic view showing an example of displaying the information about the consumer electronics apparatus 200 (air conditioner and illuminator) on the information terminal 100 in the present embodiment.

FIG. 13 is a schematic view showing an example of light emission of the consumer electronics apparatus 200 (TV receiver) when changed to a status of the information terminal 100 not being held in the present embodiment.

FIG. 14 is a diagram illustrating a list showing an example of voice recognition commands executed by the consumer electronics apparatus 200 (TV receiver) in the present embodiment.

FIG. 15 is a diagram illustrating one example (left side) of inputted program search keywords and voice recognition results and one example (right side) of program search results.

FIG. 16 is a diagram showing one example of My List.

FIG. 17 is a diagram continued from FIG. 16.

### DETAILED DESCRIPTION

According to an information terminal connectable to a target apparatus wirelessly or wiredly and having a display screen, including a determining unit and a control unit.

The determining unit determines whether the information terminal is held by a user or not.

The control unit performs to output, when changed from a status of being held to a status of not being held, a control signal to instruct accepting an operation given from the user to the target apparatus.

The control unit performs, when changed from the status of not being held to the status of being held, at least either one of displaying a remote controller to operate the target device on a display screen of the information terminal or acquiring information on a status of the target apparatus from the target apparatus to display the information on the display screen.

Hereinafter, embodiments will be described in detail with the accompany drawings.

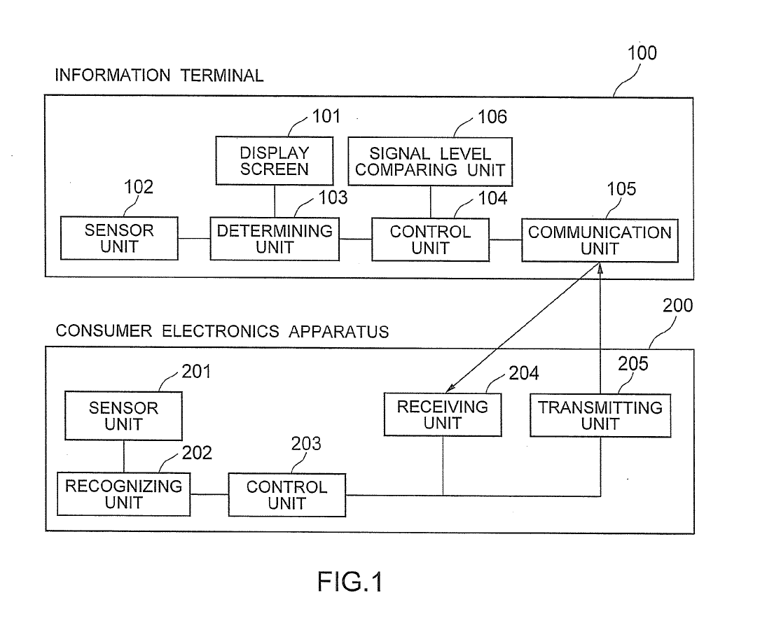

FIG. 1 is a block diagram illustrating configurations of an information terminal 100 and a consumer electronics apparatus 200 in the present embodiment. The information terminal 100 includes a display screen 101, a sensor unit 102, a determining unit 103, a control unit 104, a communication unit 105 and a signal level comparing unit 106. The consumer electronics apparatus 200 includes a sensor unit 201, a recognizing unit 202, a control unit 203, a receiving unit 204 and a transmitting unit 205, in which consumer electronics functions (which are, e.g., if being a TV receiver, a TV broadcast receiving function and a display function, and further, if being an air-conditioner, an air conditioning function) intrinsic to the consumer electronics apparatus 200 are assigned to these components. The information terminal 100 may be provided with a recognizing unit having the same function as the recognizing unit 202 has.

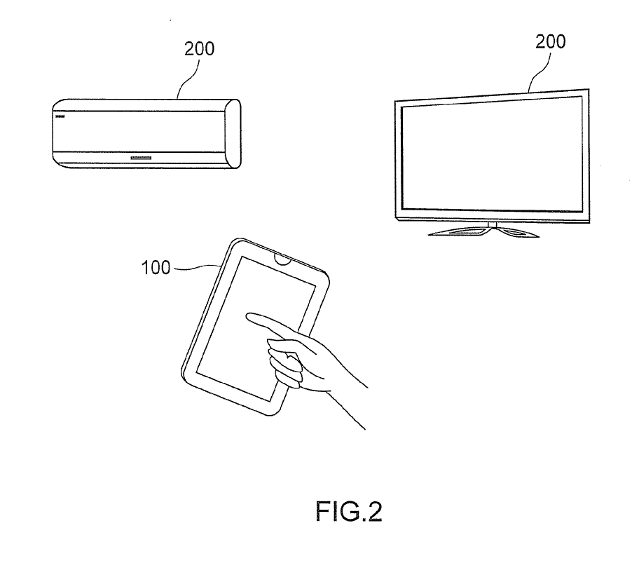

FIG. 2 is a schematic view illustrating tangible examples of the information terminal 100 and the consumer electronics apparatus 200. What is assumed as the information terminal 100 is an information terminal such as a tablet PC and a smartphone (depicted on the lower side of the drawing). The consumer electronics apparatus 200 is exemplified by a TV set (depicted on the right side of the drawing) and an air conditioner (depicted on the left side of the drawing). An assumption is that the consumer electronics apparatus 200 is mounted with a receiving unit 204 and a transmitting unit 205 that perform communications with the information terminal.

The display screen 101 of the information terminal 100 is a general type of display instrument including a liquid crystal display. In the case of the tablet PC as in FIG. 2, it is assumed that this type of PC is equipped with a touch panel function together.

The sensor unit 102 of the information terminal 100 includes at least one or more sensors, which measure movements of the information terminal 100, such as an acceleration sensor, a gyro sensor and an earth magnetism sensor that measure physical quantities varying based on the movement, an angle and an azimuth of the information terminal 100. The sensor unit 102 may also include sensors (an image sensor, a voice sensor, etc) of a camera, a microphone, etc, which input images and voices (sounds).

The communication unit 105 is assumed to perform the communications with at least one or more consumer electronics apparatuses 200 through general type of wireless communication methods such as Wi-Fi (Wireless Fidelity; registered trademark), Bluetooth (registered trademark), Zigbee (registered trademark) and infrared-ray communications, however, any inconvenience may not be caused by using wired communications.

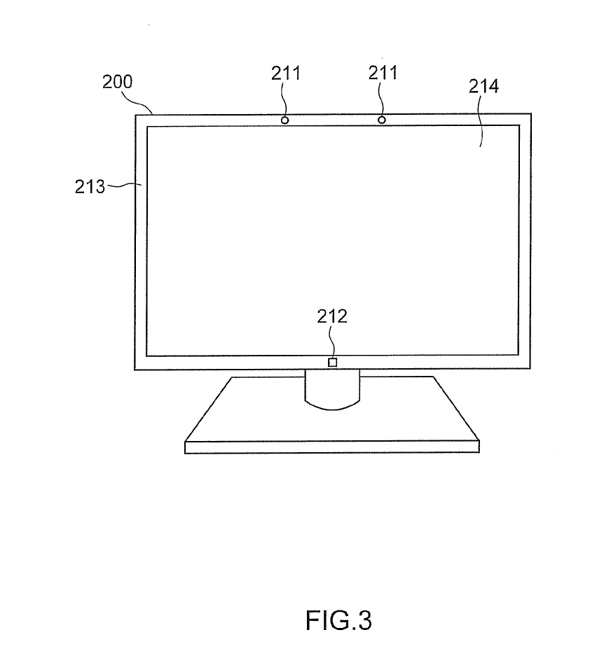

The sensor unit 201 on the side of the consumer electronics apparatus is mounted with at least one or more sensors (the image sensor, the voice sensor, etc.) of the camera, the microphone, etc for capturing a voice or a motion of a user in a distant location. FIG. 3 shows one example of an external appearance in a case where the consumer electronics apparatus 200 is the TV receiver. This example is that the sensor unit 201 is configured to incorporate two pieces of microphones 211 and a single camera 212 into a housing 213, and a display unit 214 is provided as a basic function of the TV receiver. Any inconvenience may not be caused by use of the single microphone 211, however, if two or more microphones are mounted, directivity control based on a microphone array processing technique may be executed.

It is assumed that the receiving unit 204 and the transmitting unit 205 perform the communications with the communication unit 105 on the side of the information terminal through the general type of wireless communication methods such as Wi-Fi (registered trademark), Bluetooth (registered trademark), Zigbee (registered trademark) and the infrared-ray communications, however, any inconvenience may not be caused by using the wired communications.

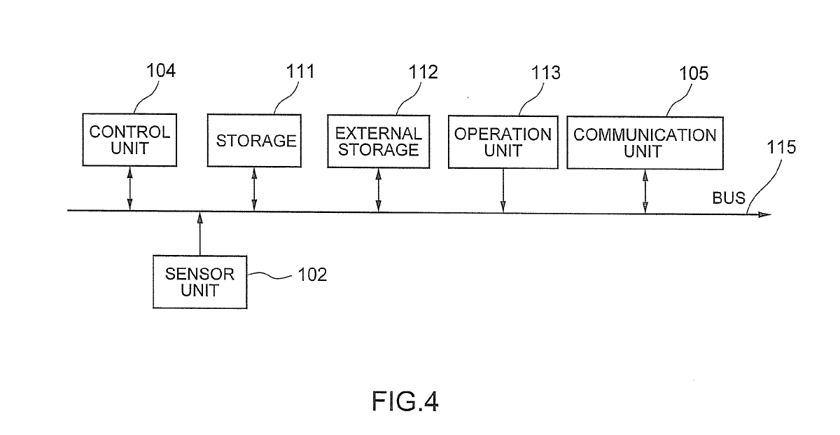

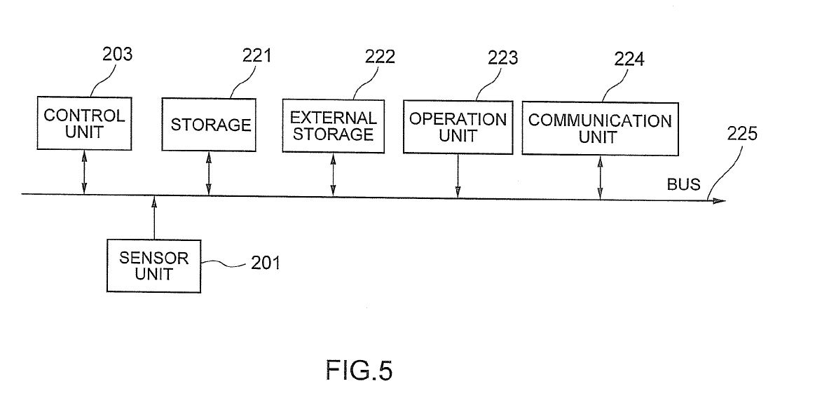

The information terminal 100 and the consumer electronics apparatus 200 are configured hardwarewise to make use of an ordinary computer as illustrated in FIGS. 4 and 5 by including a control unit 104 (203) such as a CPU (Central Processing Unit) for controlling the whole apparatus, a storage 111 (221) such as a ROM (Read Only Memory) and a RAM (Random Access Memory) that get stored with various items of data and various categories of programs, an external storage 112 (222) such as an HDD (Hard Disk Drive) and a CD (Compact Disk) drive that get stored with the various items of data and the various categories of programs, an operation unit 113 (223) that accepts an input of a user's instruction, a communication unit 105 (the communication unit 224 is configured to include the receiving unit 204 and the transmitting unit 205) which controls the communications with the external apparatuses, and a bus 115 (225) that establishes connections therebetween. Further, the sensor unit 102 (201) is connected thereto. Herein, each of the information terminal 100 and the consumer electronics apparatus 200 can be built up by a plurality of hardware components.

In the hardware configuration such as this, the control unit 104 (203) executes the various categories of programs for the determining unit 103, the recognizing unit 202, etc, which are stored in the storage 111 (221) and the external storage 112 (222) such as the ROM. Thereby, the following functions are realized.

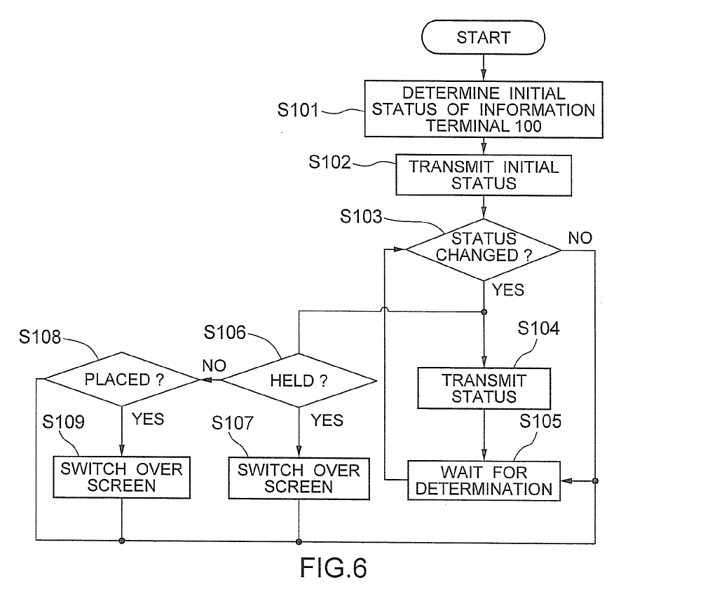

Operations of the thus-configured information terminal 100 and the thus-configured consumer electronics apparatus 200 according to the present embodiment will be described. FIG. 6 is a flowchart showing one example of a flow of processing operation of the information terminal 100 in the present embodiment. An in-depth description of respective steps of the flowchart in FIG. 6 will hereinafter be made.

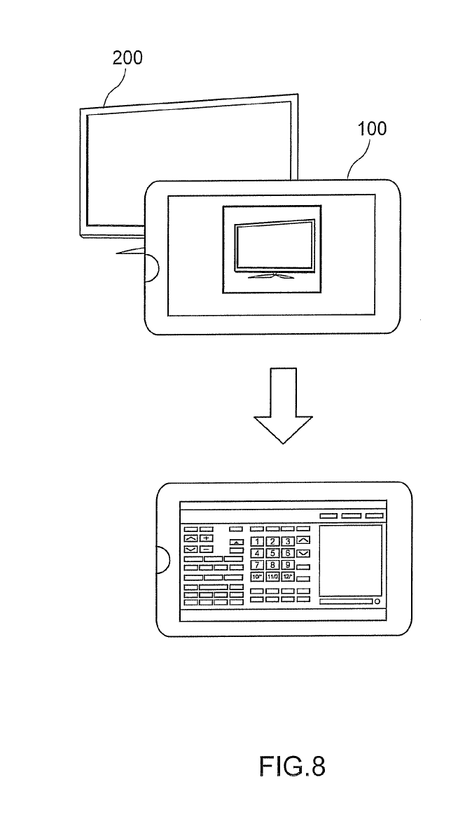

Herein, the sensor unit 102 of the information terminal 100 will be described by way of an exemplification of the acceleration sensor. Given further is a description of an example in which the consumer electronics apparatus 200 is the TV receiver, and the sensor unit 102 is configured to include the microphone 211 and the camera 212. As a matter of course, the sensors used as the sensor units 102, 201 are not limited to those sensors. Moreover, it is presumed that a relation of how each information terminal 100 is linked to at least the consumer electronics apparatus 200 set as an operating subject is to be registered beforehand by the user or automatically. A plurality of information terminals 100 may also exist. In this case, the link relation between the information terminal 100 and each operating subject consumer electronics apparatus 200 is registered per information terminal 100. Herein, the sensor unit 102 is equipped also with the camera, and the operating subject consumer electronics apparatus 200 is registered in the form of an image, in which case a suitable controller screen can be displayed on the display screen 101 as seen on the lower side of FIG. 8 by holding the information terminal 100 against the operating subject consumer electronics apparatus 200 as on the upper side of FIG. 8.

To begin with, the sensor unit 102 of the information terminal 100 measures an acceleration of the acceleration sensor, while the determining unit 103 makes a determination about an initial status of the information terminal 100 (step S101). It is desirable that the acceleration sensor is a triaxial sensor and makes the determination about the status (determines whether the user holds the tablet or not) on the basis of a position (attitude) of the information terminal 100 by monitoring a gravitational acceleration or makes the determination about the status on the basis of statistic of variances etc per unit time (e.g., one sec). In the case of monitoring the gravitational acceleration, if the gravitational acceleration along the axes, when the information terminal 100 is placed flat, is continuously stable with a value in a predetermined range approximately in the same direction, this leads to a determination that the user does not hold the information terminal 100. For instance, the value in the predetermined range may be in the vicinity of 1 [G] (between, e.g., 0.8 [G]-1.2 [G]). In the case of the status determination based on the statistic, take the variance for example, 0.0001 [G²] is set as a threshold value, it is determined that the information terminal 100 is held if exceeding this threshold value but it is determined that the information terminal 100 is not held whereas if equal to or smaller than the threshold value. As a matter of course, the threshold value is not limited to the value given above. Also, the gravitational acceleration or the statistic given as a standard is limited to the value given above.

When the determining unit 103 determines that the user does not hold the information terminal 100, the communication unit 105 transmits, to the consumer electronics apparatus 200, a first signal representing an instruction that an operating subject over the consumer electronics apparatus 200 still resides in the consumer electronics apparatus 200 (step S102). Moreover, when determining that the user holds the information terminal 100, the communication unit 105 transmits, to the consumer electronics apparatus 200, a second signal representing an instruction that the operating subject over the consumer electronics apparatus 200 resides in the information terminal 100 (step S102). Contents of the signals may be determined in a computer-interpretable format beforehand between the information terminal 100 and the consumer electronics apparatus 200. If the user does not hold the information terminal 100, power consumption can be saved by switching OFF the screen of the information terminal 100. Whereas if the user holds the information terminal 100 and if the already-link-established consumer electronics apparatus 200 exists, e.g., as in FIG. 8, the controller screen suited to operating the consumer electronics apparatus 200 is displayed, but if the link is not yet established, the screen display is not particularly changed over, or alternatively a message for prompting the user to establish the link is displayed.

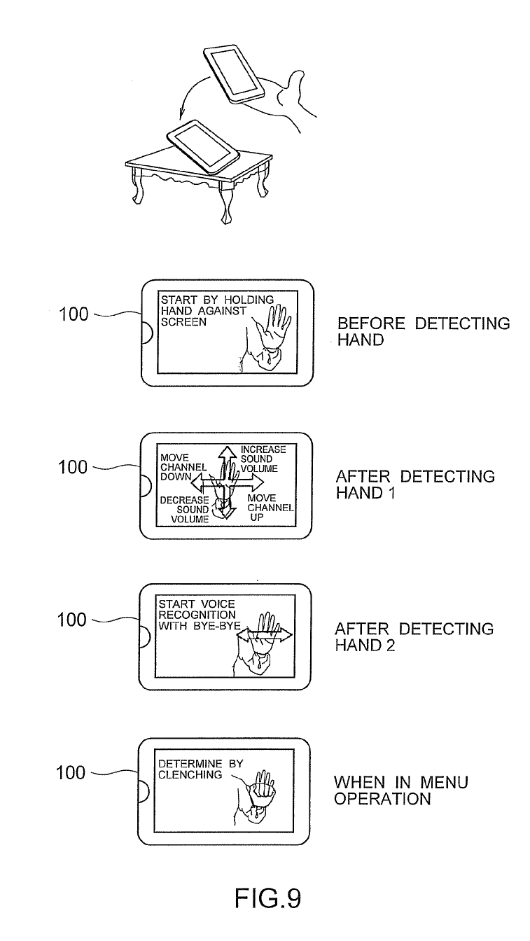

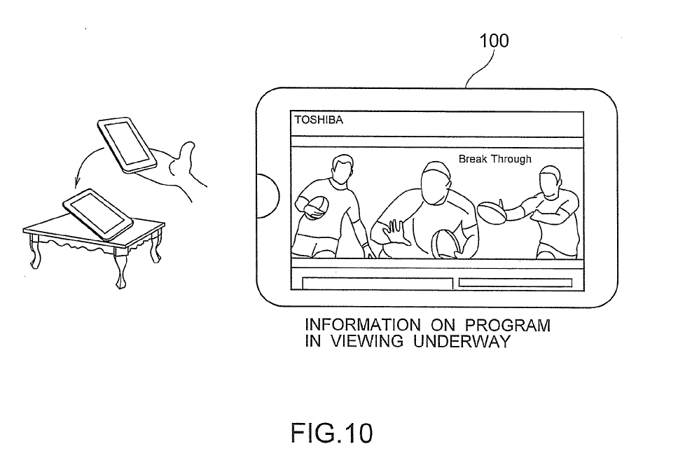

The determining unit 103 continues to make the determination about the status on the basis of the acceleration data given from the sensor unit 102 at all times, thus detecting a change in status (step S103). A status determination method of the determining unit 103 may be the same as given in step S101 and may also be different therefrom. If the status changes and when determining that the status of the user's holding the information terminal 100 has just changed to the status of not holding, the communication unit 105 transmits, to the consumer electronics apparatus 200, the first signal (a control signal representing an instruction to accept the operation from the user, e.g., a control signal representing an instruction to start up a function of recognizing a user's utterance content (language) or user's behavior) for notifying that the status of the user's holding the information terminal 100 has just changed to the status of not holding (step S104). On this occasion, the link relation between the information terminal 100 and the consumer electronics apparatus 200 is kept, and the information on the status of the operating subject consumer electronics apparatus (more specifically, the information on the status of the consumer electronics function) may be displayed on the display screen 101 of the information terminal 100 as a secondary display of the operating subject consumer electronics apparatus 200 according to the necessity (steps S108, S109). It is assumed that related items of information are exemplified by a guidance to an operation method of how the consumer electronics apparatus 200 is, as illustrated in FIG. 9, operated by not using the information terminal 100 and information related to a content in viewing underway on the consumer electronics apparatus 200 (the case of the TV receiver) as in FIG. 10. On this occasion, the consumer electronics apparatus 200 transmits the present status (a name etc of a program in viewing underway) from the transmitting unit 205, while the information terminal 100 receives the present status via the communication unit 105 and displays search results about this program on the Internet, details of an EPG (Electronic Program Guide) and websites described in the EPG on the display screen 101 (step S109).

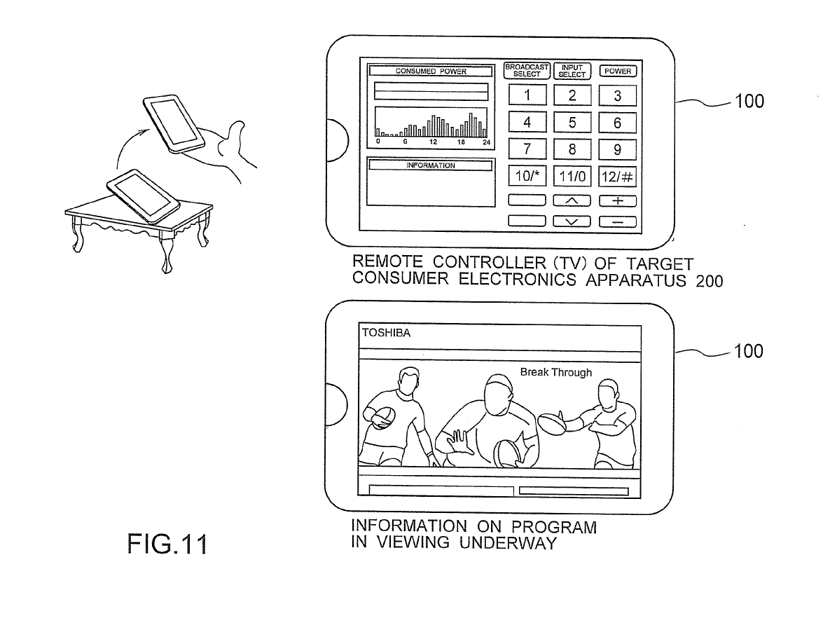

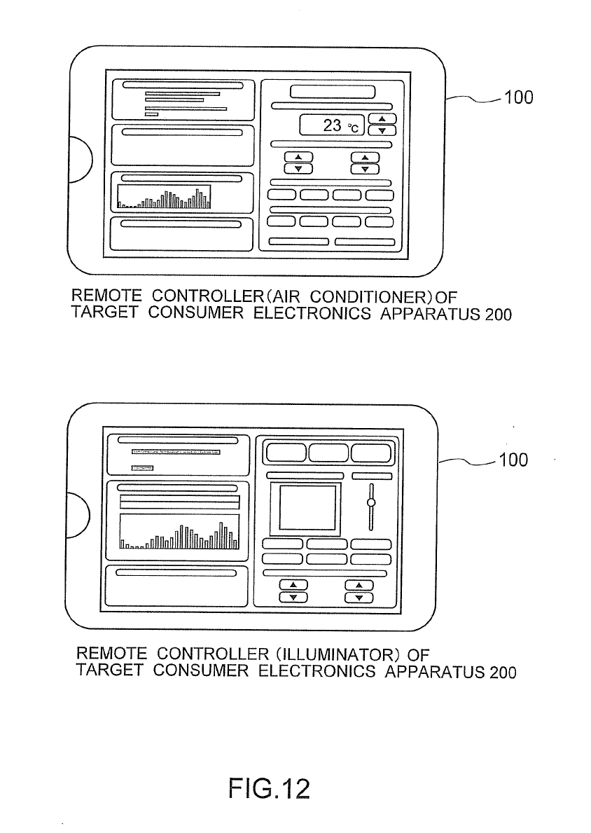

When determining that the status of the information terminal 100 not being held has just changed to the status of being held, the communication unit 105 transmits, to the consumer electronics apparatus 200, a second signal for notifying that the status of the information terminal 100 not being held has just changed to the status of being held (step S104). On this occasion, as in FIGS. 11 and 12, the display screen 101 may display remote controllers (an example of the remote controller for the TV is illustrated on the upper side in FIG. 11, an example of the remote controller for the air-conditioner is depicted on the upper side in FIG. 12, and an example of the remote controller for an illuminator is illustrated on the lower side in FIG. 12) for the operating subject consumer electronics apparatus 200 and the information (given on the lower side in FIG. 11) on the content in viewing underway (steps S106, S107). On this occasion, the consumer electronics apparatus 200 transmits the present status (the name etc of the program in viewing underway if being the TV receiver, and a present temperature, humidity and setting temperature if being the air conditioner) from the transmitting unit 205, while the information terminal 100 receives the present status via the communication unit 105 and displays the status on the display screen 101 (step S107). Also, regarding the present status displays, search results about this program on the Internet, details of an EPG (Electronic Program Guide) and websites described in the EPG may be displayed on the display screen 101 (step S107).

After transmitting the holding status (the first signal or the second signal) of the information terminal 100, the continuous detection of the change in status resumes after waiting for a predetermined determination interval (step S105).

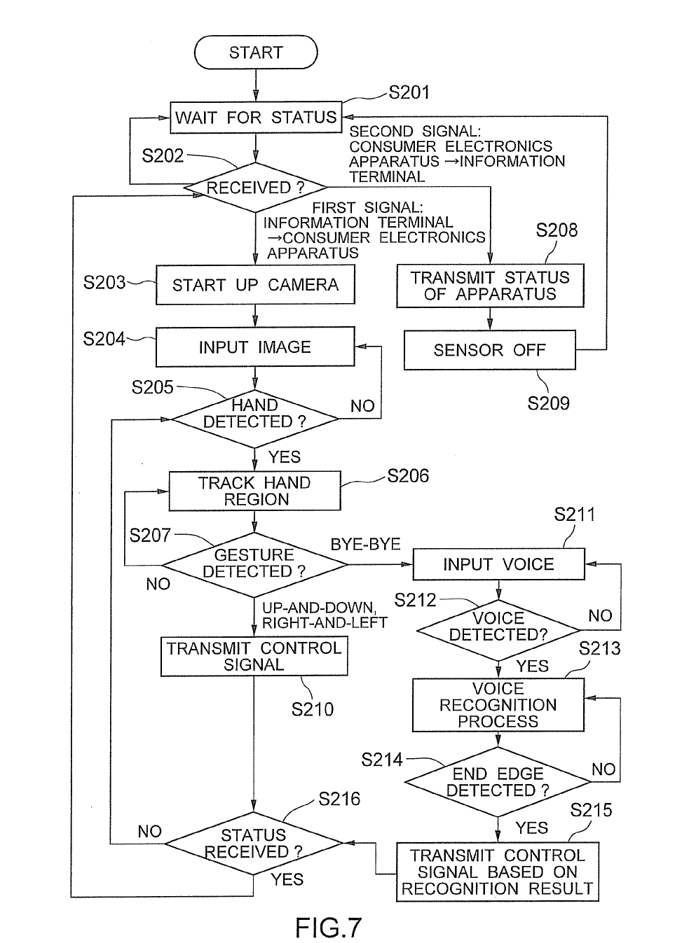

FIG. 7 is a flowchart illustrating a flow of the processing operation of the consumer electronics apparatus 200 in the present embodiment. An in-depth description of the respective steps in the flowchart of FIG. 7 will hereinafter be made.

To start with, the control unit 203 waits for receiving the information on the status from the communication unit 105 of the information terminal 100 via the receiving unit 204 (step S201). Upon a reception, the operation is switched over depending on whether the received signal is the first signal for notifying that the operating subject is set to the consumer electronics apparatus 200 or the second signal for notifying that the operating subject is set to the information terminal 100 (step S202).

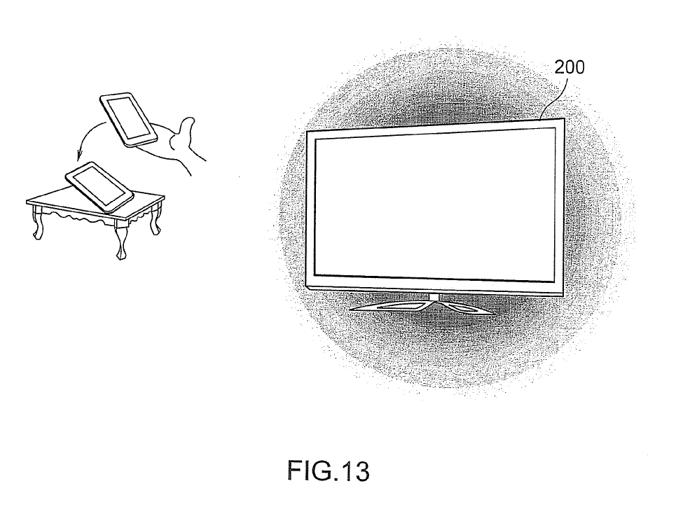

In the case of the first signal, i.e., in the case of the information terminal 100 not being held by the user, the camera of the sensor unit 201 is started up (step S203). On this occasion, the consumer electronics apparatus 200 is configured to notify the user that the sensor unit 201 becomes active so that the periphery (rear surface) of the apparatus is light up as in FIG. 13 or a light emitting element such as an LED (Light Emitting Diode) is caused to emit the light against the housing.

Each of the recognition of the user's operation from the image and the recognition of the user's operation from the voice is given by way of only one example to be just presumed but is not limited to this recognition process.

The behavior recognition function of the recognizing unit 202 is started up, and the recognizing unit 202 receives the image from the camera as an input (step S204) and detects based on the image whether the palm of the hand is held (against the screen) or not (step S205). The detection of the hand is irrespective of the method thereof such as the detection using a discriminator which learned data about the palms of a multiplicity of hands beforehand.

Upon detecting the hand, the operation is switched over to a process of tracking a motion of the hand (step S206). The tracking is irrespective of the method thereof such as a process of grasping a color and the motion of the hand.

The user's behavior, which is specifically a gesture to move the hand vertically and laterally or a bye-bye gesture, is recognized from a trajectory of tracking the regions of the hand (step S207). If the consumer electronics apparatus 200 is the TV receiver, the lateral directions may be assigned to channel forwarding (forwarding/reverse directions), while the vertical directions (up-and-down directions) may be assigned to an up-and-down operation of a sound volume. However, the assignment is not necessarily limited to what is given herein. In the case of a command to change the status of the consumer electronics apparatus 200 such as these, the consumer electronics apparatus 200 generates a control signal of switching over the apparatus to a desired status, thereby switching over the apparatus to this status (step S210).

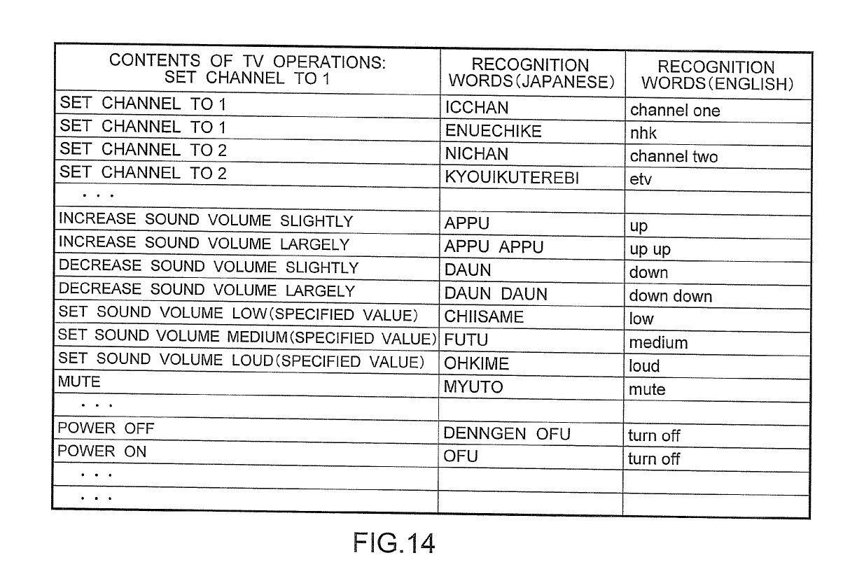

On the other hand, if the bye-bye gesture is assigned to a start of a voice recognition input, the recognizing unit 202, when recognizing the bye-bye gesture, starts inputting the voice (step S211). Namely, the voice recognizing function of the recognizing unit 202 is started up. FIG. 14 shows an example of an operation command list of the TV receiver on the basis of the voice recognition.

The recognizing unit 202, upon detecting a voice uttered by the user (step S212), starts a voice recognition process (step S213) detects an end edge (of an utterance), which involves using silence detection (step S214), thus acquires a result of the voice recognition, and generates the control signal corresponding to the result (step S215).

With the operation being thus done, if a want-to-view channel is not tangibly decided, the channel forwarding is performed based on the gesture to move the hand, whereas if the want-to-view channel is explicitly decided, the channel is switched over by directly inputting a voice of the channel name. Thus, it becomes possible to switch over the channel by a proper method corresponding to a situation of the user.

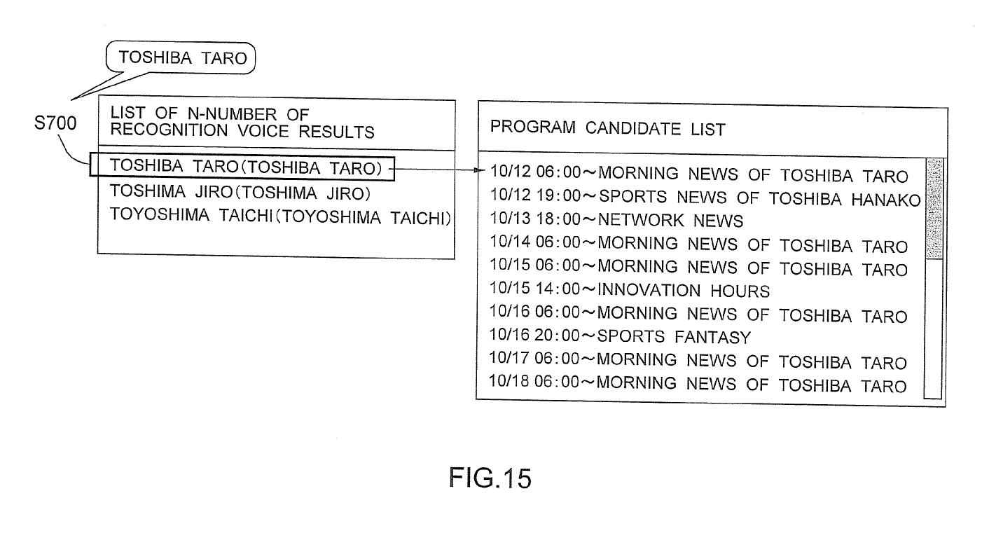

Further, in the case of starting up the voice recognition when normally viewing, there is activated a local type voice recognition engine supporting basic operation commands with a small number of words, which functions on the recognizing unit 202 of the consumer electronics apparatus 200. In the case of starting up the voice recognition in a scene of searching for the program, there is activated a server type voice recognition engine supporting commands with a large number of words corresponding to a program name and a name of a person. Thereby, the voice recognition suited to each scene can be used. The local type voice recognition engine is suited to the case of the basic operation because of readiness being important even when the number of words is limited, while the server type voice recognition engine is suited to the scene such as when searching for the program because of requiring the high-performance voice recognition with the large number of words even when a response requires a bit longer period of time. The left side in FIG. 15 shows an example of the voice recognition input and an example of recognition results when searching for the program. A menu is selected by moving a cursor with the gesture to move the hand in the up-and-down directions and is determined by a clenching gesture. The right side in FIG. 15 shows an example of a program candidate list of the search results based on keywords determined on the left side in FIG. 15.

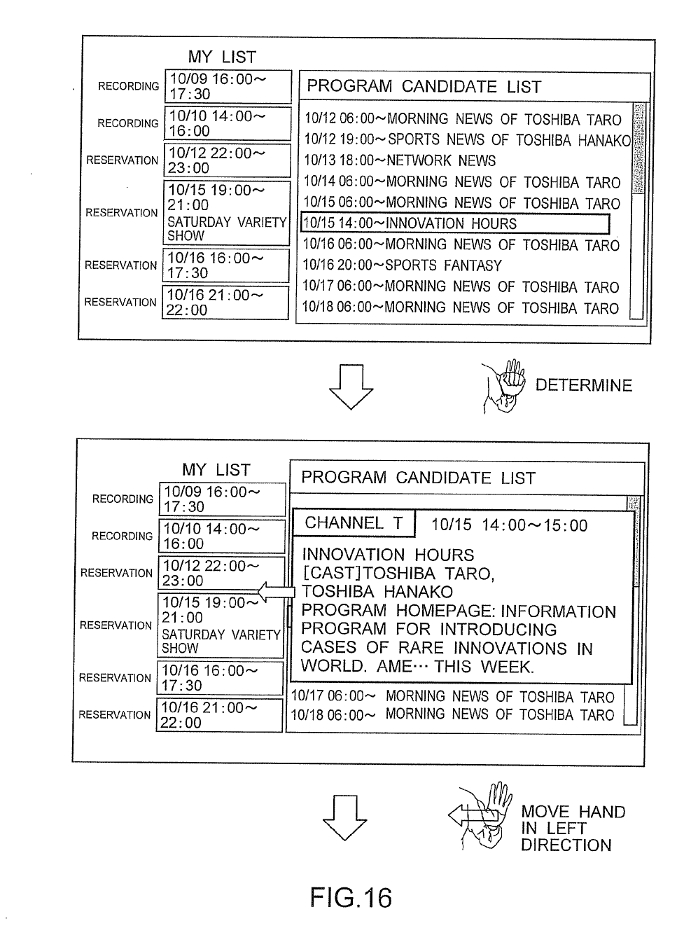

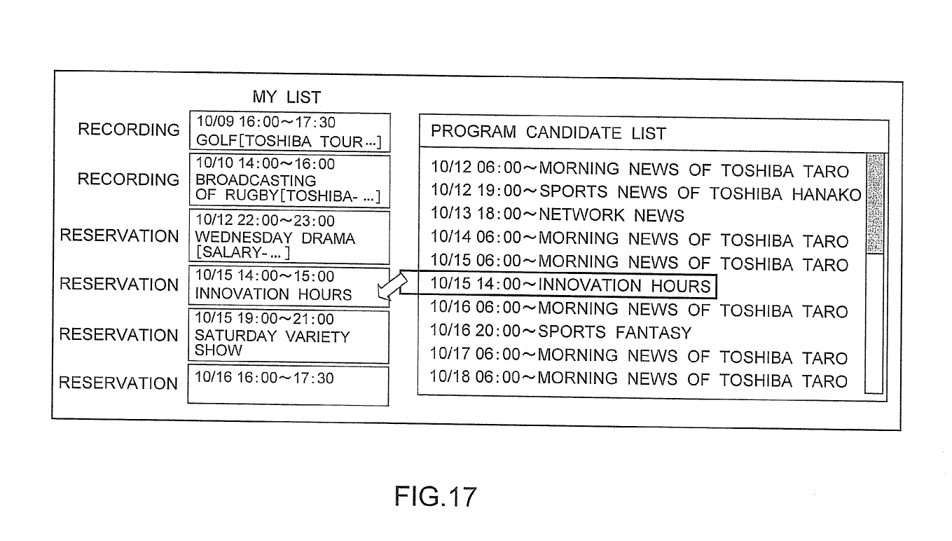

In this connection, herein, when the target program is selected by the up-and-down hand moving gesture and determined by the clenching gesture, as in FIG. 16, it is feasible to refer to detailed information of the selected program. Further, on this occasion, a list area dedicated to the user (which will hereinafter be called a My List) is provided on the left side of the screen, in which the selected program is added to the My List as in FIG. 17 by conducting a leftward hand moving gesture against a detailed information reference screen, thus enabling realization of an intuitive operation based on a positional relation on the screen. Herein, My List is defined as a function of managing batchwise the programs that are thus selected by the user (in which the user is interested) on a time base, and represents a program guide dedicated to the user. In My List, there are arranged past-recorded programs and reserved programs scheduled to be broadcasted from now on. This function enables the user to easily access the interesting program added to the My List in the past. Note that items reserved for recording at the present are already-recorded items if the recording has been completed with an elapse of time. This purport may be displayed or may also be set recognizable to the user by displaying a thumbnail etc.

The status given from the information terminal 100 continues to be received also during the activations of the camera and the microphone, and, when receiving a status change signal, the same processes as those described above are executed again (step S216).

Further, in the description given above, when the operating subject resides in the consumer electronics apparatus 200, the sensor unit 201 on the side of the consumer electronics apparatus 200 is all used. However, in the case that the sensor unit 102 on the side of the information terminal 100 includes the same type of sensor, the information terminal 100 may realize such a function that a signal level comparing unit 106 evaluates an input level of the signal of the sensor of the information terminal 100 itself and an input level of the signal of the sensor of the consumer electronics apparatus 200, and the signal exhibiting a better status (e.g., a higher S/N ratio) is used. For example, if the information terminal 100 is placed horizontally on the top of a desk nearby the user, the microphone (voice sensor) is closer to the user than the microphone of the consumer electronics apparatus 200, and it is therefore presumed better to perform the voice recognition input from the microphone of the information terminal 100. In this case, the input voice acquired by the microphone of the information terminal 100 is transmitted to the consumer electronics apparatus 200 via the communication unit, and the recognizing unit 202 of the consumer electronics apparatus 200 recognizes the input voice acquired on the side of the information terminal 100. Note that when the information terminal 100 is placed horizontally, this posture is not suited to the hand moving recognition of the user in many cases because of the camera being directed perpendicularly. However, if suited, any inconvenience may not be caused by using the camera of the information terminal 100.

Moreover, another example of the configuration may be adopted as follows: the consumer electronics apparatus 200, if the operating subject resides in the consumer electronics apparatus 200 itself, activates the voice sensor of the information terminal 100, measures the S/N (signal-to-noise) ratio of the input voice of the voice sensor, and transmits the input voice acquired by the voice sensor of the information terminal 100 to the consumer electronics apparatus 200 via the communication unit if the S/N ratio is equal to or larger than a threshold value, and the recognizing unit 202 of the consumer electronics apparatus 200 may recognize the input voice acquired on the side of the information terminal 100. In this case, the content uttered by the user, which is recognized by the recognizing unit, is transmitted to the consumer electronics apparatus 200, and the consumer electronics apparatus 200 specifies, based on the information representing the uttered content received from the information terminal 100, a content of the operation, and controls the consumer electronics function of the consumer electronics apparatus 200 itself.

In the embodiment described above, the consumer electronics apparatus 200, when receiving the first signal for notifying that the status of the information terminal 100 being held has just changed to the status of not being held, activates the recognizing unit (the voice recognizing function or the behavior recognizing function), and the operation given from the user can be thereby accepted. However, the acceptance of the operation given from the user can be realized otherwise. For instance, the consumer electronics apparatus 200 is equipped with a touch panel function and activates the touch panel function when receiving the first signal, and the operation from the user may be thus acceptable. Further, when receiving the second signal, the touch panel function is terminated, and the operating subject may also be transferred to the information terminal 100.

As discussed above, according to the present embodiment, the operation by the information terminal and the operation by the sensor on the side of the consumer electronics apparatus can be automatically switched over properly depending on the holding status of the information terminal. With this switchover of the operation, even when not holding the information terminal with the hand or when the information terminal is located distantly, the consumer electronics apparatus can be operated by a spontaneous method. For example, the consumer electronics apparatus is operated on the side of the information terminal when holding the information terminal, however, if the information terminal is not held, the user can give the instructions directly to the target consumer electronics apparatus through the gestures, the voices, etc by activating the sensor on the side of the target consumer electronics apparatus. Further, the reference to the information on the status of the consumer electronics apparatus can be easily made simply by holding the information terminal with the hand.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information terminal connectable to a target apparatus, comprising:
a determining unit configured to determine whether the information terminal is held by a user or not; and
a control unit configured to
perform to output, when changed from a status of being held to a status of not being held, a control signal to instruct accepting an operation given from the user to the target apparatus, and
perform, when changed from the status of not being held to the status of being held, at least either one of displaying a remote controller to operate the target device on a display screen of the information terminal or acquiring information on a status of the target apparatus from the target apparatus to display the information on the display screen.

2. The information terminal according to claim 1, wherein the control signal is a control signal to instruct activating a recognizing function to recognize a content uttered by the user or a behavior of the user.

3. The information terminal according to claim 1, wherein the control unit acquires, when changed from the status of being held to the status of not being held, the information on the status of the target apparatus from the target apparatus and displays the information on the display screen.

4. The information terminal according to claim 1, further comprising:
a sensor unit configured to measure a motion of the information terminal,
wherein the determining unit determines whether the information terminal is held or not on the basis of the motion measured by the sensor unit.

5. The information terminal according to claim 1, further comprising:
a voice sensor configured to detect a voice signal,
wherein the control unit determines whether an S/N ratio of the voice signal detected by the voice sensor is equal to or larger than a threshold value when changed from the status of being held to the status of not being held, and outputs the voice signal to the target apparatus if the S/N ration is equal to or larger than the threshold value.

6. The information terminal according to claim 1, further comprising:
a voice sensor configured to detect a voice signal; and
a recognizing unit configured to perform a voice recognition based on the voice signal to acquire information representing a content uttered by the user,
wherein the control unit determines whether a S/N ratio of the voice signal detected by the voice sensor is equal to or larger than a threshold value when changed from the status of being held to the status of not being held, and, if the S/N ratio is equal to or larger than the threshold value, starts up the recognizing unit and outputs the information representing the content uttered by the user acquired by the recognizing unit to the target apparatus.

7. A consumer electronics apparatus connectable to at least one of information terminals and having a predetermined consumer electronics function, comprising:
a sensor unit configured to measure information related to a voice or a motion of a user;
a receiving unit configured to receive a first signal for notifying that a status of the information terminal being held by the user has changed to a status of not being held or a second signal for notifying that the status of the information terminal not being held by the user has changed to the status of being held from the information terminal;
a recognizing unit configured to execute a recognition process based on the information measured by the sensor unit and to acquire information representing a content uttered by the user or a behavior of the user; and
a control unit configured to
start up the recognizing unit when the receiving unit receives the first signal, and control the predetermined consumer electronics function on the basis of the content uttered by the user or the behavior of the user acquired by the recognizing unit, and
terminate the recognizing unit when the receiving unit receives the second signal, and transmit information on a status of the predetermined consumer electronics function to the information terminal.

8. An information processing method for an information terminal connectable to a target apparatus, comprising:
determining whether the information terminal is held by a user or not; and
performing to output, when changed from a status of being held to a status of not being held, a control signal to instruct accepting an operation given from the user to the target apparatus, and
performing, when changed from the status of not being held to the status of being held, at least either one of displaying a remote controller to operate the target device on a display screen of the information processing or acquiring information on a status of the target apparatus from the target apparatus to display the information on the display screen.

9. A non-transitory computer readable medium having stored therein instructions, which when executed by a processor, causes the processor to perform steps comprising:
determining whether an information terminal is held by a user or not, the information terminal being connectable to a target apparatus, comprising:
performing to output, when changed from a status of being held to a status of not being held, a control signal to instruct accepting an operation given from the user to the target apparatus, and
performing, when changed from the status of not being held to the status of being held, at least either one of displaying a remote controller to operate the target device on a display screen of the information terminal or acquiring information on a status of the target apparatus from the target apparatus to display the information on the display screen.
